(19) United States
(12) Patent Application Publication
(10) Pub. No.: US 2002/0032116 A1
(43) Pub. Date: Mar. 14, 2002

(54) SALINE SOLUBLE INORGANIC FIBRES

(76) Inventors: GARY ANTHONY JUBB, KIDDERMINSTER (GB); PAUL NIGEL EATON, KIDDERMINSTER (GB); PHILIP JOHN CANTY, KIDDERMINSTER (GB); ALISON JANE WASSELL, KIDDERMINSTER (GB)

Correspondence Address: JOHN S PRATT, KILPATRICK & STOCKTON, 1100 PEACHTREE STREET, SUITE 2800, ATLANTA, GA, 30309-4530, US

(21) Appl. No.: 09/202,758

(22) PCT Filed: Jun. 20, 1997
(86) PCT No.: PCT/GB97/01667

(30) Foreign Application Priority Data
Jun. 21, 1996 (GB) 9613023.2

(51) Int. Cl. C03C 13/06

(52) U.S. Cl. 501/36; 501/72

(57) ABSTRACT

The use of P2O5 and or B2O3 as a component to improve the refractoriness of inorganic fibres comprising SiO 2, and CaO and/or MgO is described. The inorganic fibres have a composition such that SiO 2+P2O5 (58+(if MgO 10, 0.5×(MgO10) else 0)) 2.4 wt. %.

This invention relates to saline soluble inorganic fibres.

Saline soluble inorganic fibres have been described in several patent specifications, see for example WO93/15028. Fibres are required to be soluble in saline solution so that inhaled or ingested fibres dissolve rather than providing a source of irritation or otherwise affecting health. WO93/15028 showed that fibres comprising SiO₂, CaO and MgO and having a silica content of greater than 58% (or greater than 58% plus 0.5 times (wt % MgO-10) if MgO>10 wt %) had suitable shrinkage characteristics at 800° C. and 1000° C. to be usable as refractory materials. A further feature of WO93/15028 was the use of the percentage of non-bridging oxygens present to predict the solubility of fibres in physiological saline solution.

Various subsequent applications have described the effect of P₂O₅ and B₂O₃ on solubility—see for example WO95/29135. P₂O₅ is alleged to have a solubilising effect on such fibres. WO93/22251 refers to use of P₂O₅ and Na₂O to improve solubility of fibres. WO89/12032 and DE 4417230 disclose fibres containing SiO₂, CaO, MgO, and B₂O₃.

The German government have proposed a fibre classification which turns on a variable K₁ which is defined as:

K₁=Σ(Na,K,B,Ca,Mg,Ba-oxide)−2* Al-oxide

(the amounts of the oxides being expressed as weight %)

According to the proposed fibre classification if K₁ is greater than 40 the fibre requires no health warnings. If K₁ lies between 30 and 40 the fibre requires health warnings to be made. If K₁ is less than 30 more serious marking is required (it is labelled as a carcinogen). It is readily apparent that it is difficult to provide a high K₁ fibre (K₁>40) while still providing a refractory fibre like that of WO93/15028 (SiO₂>58 wt %), there being a very narrow window of compositions to meet.

As a result of investigating fibre compositions that may meet the fibre classification and yet still be refractory enough to meet the standard of WO93/15028 (shrinkage of less than 3.5% at both 800° C. and 1000° C.) the applicants have found that addition of P₂O₅ to compositions allows a broader range of refractory fibres to be produced than had previously been appreciated.

They have also found that B₂O₃, previously thought to be extremely detrimental to refractoriness, has a similar, although lesser, effect and that both P₂O₅ and B₂O₃ may be used in the fibres of WO93/15028.

The applicants have found that the refractoriness of the P₂O₅ and B₂O₃ containing fibres of the present invention is dependent on the sum of the amounts of SiO₂ and P₂O₅ (expressed in wt %)

It appears that a further factor that may be important in determining the refractoriness of a fibre is the percentage of non-bridging oxygens. If this percentage is 61.4% or more (calculated on the basis of the amounts of the components SiO₂, CaO, MgO, P₂O₅, and B₂O₃) the fibres tend to fail shrinkage tests at 800° C. and 1000° C. (failure being defined as a shrinkage of 3.5% or more).

The scope of the invention is apparent from the claims in the light of the following description.

The percentage of non-bridging oxygens (%N.B.O.) is calculated by converting the weight percentages of SiO₂, CaO, MgO, P₂O₅, and B₂O₃ to molar amounts and inserting these amounts into the equation:

$$\% N . B . O . = \frac{2 * ( CaO + MgO + {P}_{2} {O}_{5} + {B}_{2} {O}_{3} )}{\begin{matrix}( 2 * {SiO}_{2} + CaO + MgO + \\ 5 \times {P}_{2} {O}_{5} + 3 \times {B}_{2} {O}_{3} )\end{matrix}} \times 100$$

The reason the amounts of CaO, MgO, P₂O₅, and B₂O₃ are doubled in the numerator to this equation is that each contributes two non-bridging oxygens. The reason terms are multiplied in the denominator to this equation is to reflect the number of oxygen atoms each molecular formula possesses.

Table I shows the results of a first set of shrinkage and solubility tests on compositions comprising SiO₂, CaO, MgO, P₂O₅, and B₂O₃ as main ingredients. In this table the analysed compositions are normalised to 100%. It is clear from these compositions that where the percentage of non-bridging oxygens calculated on the basis of the amounts of the above named components is greater than 61.4% (those fibres lying above line A of Table I) the fibres fail the shrinkage tests, having shrinkages of greater than 3.5% at either or both of 800° C. and 1000° C.

WO93/15028 stressed the importance of alumina content and the fibres lying between lines B and A of Table I show that alumina contents of greater than 1 wt % are damaging to the shrinkage properties of fibres.

The applicants have also found that the combined amount of CaO and MgO is important. Those fibres lying between lines C and B have a combined CaO and MgO content of greater than 42 wt % and also fail the shrinkage tests.

The fibres below line C have a percentage of non-bridging oxygens less than 61.4%, an alumina content of less than 1 wt %, and a combined CaO and MgO content of less than 42 wt %. All of these fibres pass the shrinkage tests These fibres fall within the compositional ranges:

SiO₂ 52.4-57.85 wt %

CaO 22.2-39.4 wt %

MgO 1.96-17.4 wt %

P₂O₅ 0.82-7.8 wt %

B₂O₃ 0-1.95 wt %

Al₂O₃ <1 wt %

The solubility results presented in Table I were obtained by the methods described in WO93/15028 and show a high solubility for all of the fibres produced.

It can be seen that all of the fibres below line C have a K₁ of more than 35 and more than half have a K₁ of more than 40.

Further testing resulted in the data presented in Table II. The data presented are as in table I but an additional column entitled deviation shows the result of looking to the difference between the sum of the SiO₂ and P₂O₅ contents and the SiO₂ amount predicted to be needed by WO93/15028 for a fibre to be refractory (shrinkage of less than 3.5% at both 800° C. and 1000° C. The figure given is found by calculating the sum

SiO₂+P₂O₅-(58+(if MgO>10, 0.5×(MgO-10) else 0))

If this is less than −2.4 wt % the fibres fail. The fibres that failed are shown in plain text, those that passed in bold text, and those that were difficult to form in italics.

More than 12.5 wt % P₂O₅ is undesirable as it causes difficulties in making the fibres.

While the above description and the claims refer to P₂O₅, B₂O₃, SiO₂, CaO and MgO it will be clear to the person skilled in the art that the pure materials need not be used and that provision of these components in combined form (e.g. provision of P₂O₅ in the form of mixed oxide phosphates) is part of the invention.

TABLE I

| Code | Chemical Composition (XRF - Weight percent) | | | | | | | | | | | |
|---|---|---|---|---|---|---|---|---|---|---|---|---|
| LTP | CaO | MgO | P2O5 | SiO2 | Al2O3 | Na2O | K2O | B2O3 | Fe2O3 | ZrO2 | SrO | Kl |
| LTP8 | 24.95 | 19.18 | 3.41 | 51.69 | 0.25 | 0.30 | 0.05 | | 0.17 | <0.05 | <0.05 | 44.0 |
| LTP9 | 24.81 | 18.66 | 5.10 | 50.42 | 0.38 | 0.31 | <0.05 | | 0.17 | 0.15 | <0.05 | 43.0 |
| LTP11 | 25.13 | 19 07 | 2.51 | 52.54 | 0.28 | 0.25 | 0.05 | | 0.17 | <0.05 | <0.05 | 43.9 |
| LTP16 | 31.83 | 12.27 | 3.39 | 51.59 | 0.26 | 0.42 | 0.06 | | 0.17 | <0.05 | <0.05 | 44.1 |
| LTP10 | 24.48 | 17.89 | 2.48 | 54.46 | 0 21 | 0.28 | 0.05 | | 0.16 | <0.05 | <0.05 | 42.3 |
| LTP 4 | 24.04 | 17.78 | 3.31 | 53.85 | 0.31 | 0.26 | 0.05 | | 0.15 | 0.25 | <0.05 | 41.5 |
| LTP 5 | 24.22 | 17.17 | 4.91 | 52.72 | 0.33 | 0.30 | <0.05 | | 0.14 | 0.21 | <0.05 | 41.0 |
| LTP17 | 38.39 | 5.54 | 3.41 | 51.22 | 0.40 | 0.42 | 0.07 | | 0.16 | 0.38 | <0.05 | 43.6 |
| LTP23 | 38.62 | 5.56 | 2.57 | 52.23 | 0 34 | 0.46 | 0.07 | | 0.15 | <0.05 | <0.05 | 44.0 |
| LTP14 | 30 93 | 11.01 | 4.90 | 51.96 | 0.30 | 0.45 | 0.05 | | 0.15 | 0.25 | <0.05 | 41.8 |
| LTP13 | 11.28 | 27.95 | 3.26 | 57.2 | <0.05 | 0.13 | <0.05 | | 0.17 | <0.05 | <0.05 | 39.4 |
| LTP12 | 30.93 | 11.35 | 3.36 | 53.52 | 0.32 | 0.31 | 0.06 | | 0.15 | <0.05 | <0.05 | 42.0 |
| LTP20 | 31.05 | 11 35 | 2.52 | 54.14 | 0.32 | 0.31 | 0.06 | | 0.16 | 0.10 | <0.05 | 42.1 |
| LTP15 | 36 89 | 5 70 | 5.05 | 51 22 | 0 31 | 0.43 | 0.10 | | 0.16 | 0.13 | <0.05 | 42.5 |
| LTP 3 | 22 89 | 16.69 | 6.70 | 52.58 | 0.25 | 0.29 | <0.05 | | 0.14 | 0.46 | <0.05 | 39.4 |
| LTP 7 | 10.37 | 27.85 | 3.29 | 58.18 | <0.05 | 0.15 | <0.05 | | 0.16 | <0.05 | <0.05 | 38.4 |
| LTP52 | 24.9 | 11.5 | 4.89 | 54.8 | 2.06 | 0.28 | 0.05 | <0.05 | 1.38 | <0.05 | <0.05 | 32.6 |
| LTP51 | 28 7 | 11 | 1.62 | 56.6 | 1.38 | 0.29 | 0.07 | <0.05 | 0.26 | <0.05 | <0.05 | 37.3 |
| LTP29 | 40.29 | 2.09 | 1.23 | 55.09 | 0.43 | 0.39 | 0.12 | | 0.19 | 0.17 | <0.05 | 42.0 |
| LTP21 | 36.62 | 5.58 | 2.54 | 54.19 | 0 39 | 0.46 | 0.07 | | 0.15 | <0.05 | <0.05 | 42.0 |
| LTP30 | 39.40 | 1.96 | 2.22 | 55.25 | 0.45 | 0.41 | 0.10 | | 0.21 | <0.05 | <0.05 | 41.0 |
| LTP41 | 31.36 | 9.48 | 0.85 | 55.63 | 0.27 | 0.30 | 0.07 | 1.88 | 0.16 | <0.05 | <0.05 | 42.5 |
| LTP 6 | 29.83 | 10.45 | 3.34 | 55.65 | 0.21 | 0.32 | 0.05 | | 0.15 | <0.05 | <0.05 | 40.2 |
| LTP34 | 30.44 | 9.81 | 1.68 | 57.3 | 0 25 | 0.31 | 0.07 | | 0.15 | <0.05 | <0.05 | 40.1 |
| LTP43 | 30 51 | 9.68 | 1.68 | 56 19 | 0.28 | 0.32 | 0.07 | 1.11 | 0.15 | <0.05 | <0.05 | 41.1 |
| LTP42 | 30.55 | 9.56 | 0.86 | 57.13 | 0.27 | 0.33 | 0.07 | 1.08 | 0.15 | <0.05 | <0.05 | 41.1 |
| LTP47 | 22.2 | 17.4 | 3.98 | 55.2 | 0.31 | 0.31 | 0.05 | <0.05 | 0.1 | <0.05 | <0.05 | 39.3 |
| LTP38 | 34.82 | 4.73 | 0.82 | 57.84 | 0.31 | 0.30 | 0.08 | 0.94 | 0.15 | <0.05 | <0.05 | 40.3 |
| LTP 2 | 23.35 | 16.10 | 4.87 | 54.25 | 0.46 | 0.24 | <0.05 | | 0.16 | 0.58 | <0.05 | 38.8 |
| LTP39 | 34.35 | 4.73 | 1.67 | 57.39 | 0 27 | 0.30 | 0.08 | 1.06 | 0.14 | <0.05 | <0.05 | 40.0 |
| LTP 1 | 23.29 | 15.66 | 3.33 | 57.01 | 0.24 | 0.22 | 0.06 | | 0.14 | <0.05 | 0.05 | 38.7 |
| LTP48 | 32 | 6.87 | 7.8 | 52.4 | 0.52 | 0.34 | 0.05 | <0.05 | 0.15 | 0.18 | <0.05 | 38.2 |
| LTP40 | 33.67 | 4.75 | 0.86 | 57.85 | 0.38 | 0.31 | 0.08 | 1.95 | 0.15 | <0.05 | <0.05 | 40.0 |
| LTP26 | 33.69 | 4.56 | 3.73 | 56.95 | 0.36 | 0.43 | 0.06 | | 0.14 | 0.07 | <0.05 | 38.0 |
| LTP27 | 28.91 | 9.33 | 3.66 | 57.32 | 0.22 | 0.36 | 0.05 | | 0.14 | <0.05 | <0.05 | 38.2 |
| LTP46 | 28.4 | 8.69 | 2.67 | 59 | 0.29 | 0.33 | 0.06 | <0.05 | 0.13 | <0.05 | <0.05 | 36.9 |

| Code | Shrinkage | | Solubility (ppm) | | | | | | | |
|---|---|---|---|---|---|---|---|---|---|---|
| LTP | 800° C. | 1000° C. | CaO | MgO | SiO2 | B2O3 | Total | CaO + MgO | % N.B.O. | |
| LTP8 | 40.0 | 40.0 | 53 | 98 | 177 | | 328 | 44.14 | 68.5% | A |
| LTP9 | 23.9 | 38.8 | 59 | 115 | 193 | | 367 | 43.47 | 68.1% | |
| LTP11 | 46.8 | 39.1 | 55 | 94 | 174 | | 323 | 44.20 | 68.0% | |
| LTP16 | 49.1 | | 79 | 76 | 200 | | 355 | 44.11 | 66.1% | |
| LTP10 | 3.62 | 19.1 | 58 | 90 | 169 | | 317 | 42.37 | 64.7% | |
| LTP 4 | 3.71 | 4.77 | 56 | 95 | 180 | | 331 | 41.83 | 64.3% | |
| LTP 5 | 3.63 | 5.39 | 65 | 106 | 191 | | 362 | 41.40 | 64.1% | |
| LTP17 | 45.2 | 43.8 | 83 | 32 | 191 | | 306 | 43.94 | 63.9% | |
| LTP23 | 42.90 | | 82 | 29 | 199 | | 310 | 44.18 | 63.7% | |
| LTP14 | 3.24 | 3.92 | 78 | 69 | 191 | | 338 | 41.95 | 63.0% | |
| LTP13 | 5.72 | 5.26 | 30 | 117 | 188 | | 335 | 39.23 | 63.0% | |
| LTP12 | 2 55 | 30.1 | 82 | 72 | 207 | | 361 | 42.27 | 62.6% | |
| LTP20 | 3.38 | 29.7 | 85 | 71 | 200 | | 356 | 42.40 | 62 6% | |
| LTP15 | 3.41 | 5.03 | 88 | 35 | 204 | | 327 | 42 59 | 62 2% | |
| LTP 3 | 23.3 | 29.5 | 43 | 166 | 141 | | 350 | 39.58 | 61.9% | |
| LTP 7 | 10.9 | 15.5 | 36 | 132 | 152 | | 320 | 38.23 | 61.4% | |
| LTP52 | 32.1 | | 72 | 74 | 140 | | 286 | 36.40 | 56.0% | |
| LTP51 | 3.07 | 3.61 | 82 | 69 | 159 | | 310 | 39.70 | 58.4% | |
| LTP29 | 45.9 | | 76 | 10 | 206 | | 292 | 42.38 | 58.8% | |
| LTP21 | | 35.5 | 58 | 34 | 208 | | 300 | 42.20 | 60.3% | |
| LTP30 | 1.74 | 2.04 | 72 | 11 | 209 | | 292 | 41.36 | 57.5% | |
| LTP41 | 1.20 | 2.32 | 87 | 60 | 194 | 20 | 361 | 40.84 | 60.0% | |
| LTP 6 | 1.89 | 2.76 | 65 | 52 | 172 | | 289 | 40.28 | 59.0% | |
| LTP34 | 1.40 | 1.79 | 76 | 51 | 188 | | 315 | 40.25 | 58.0% | |
| LTP43 | 0.97 | 1.84 | 62 | 66 | 187 | 12 | 327 | 40.19 | 58.8% | |
| LTP42 | 1.04 | 1.81 | 75 | 65 | 192 | 12 | 344 | 40 12 | 58.2% | |
| LTP47 | 1.97 | 2.14 | 58 | 104 | 197 | | 359 | 39.60 | 61.0% | |
| LTP38 | 1.07 | 1.40 | 83 | 25 | 175 | 9 | 292 | 39.56 | 55.4% | |
| LTP 2 | 2.24 | 3.05 | 53 | 96 | 167 | | 316 | 39.45 | 60.8% | |
| LTP39 | 1.47 | 1.93 | 32 | 33 | 203 | 16 | 284 | 39.08 | 55.2% | |
| LTP 1 | 1.31 | 1.77 | 63 | 89 | 175 | | 327 | 38.94 | 58.7% | |
| LTP48 | 1.24 | 1.53 | 84 | 48 | 205 | | 337 | 38 87 | 57.7% | |
| LTP40 | 1.15 | 2.39 | 40 | 32 | 194 | 25 | 291 | 38.42 | 54.5% | |
| LTP26 | 1.22 | 1.40 | 91 | 28 | 193 | | 312 | 38.25 | 54.0% | |
| LTP27 | 0.99 | 1.16 | 67 | 48 | 173 | | 288 | 38.24 | 55.5% | |
| LTP46 | 0.91 | 0.99 | 71 | 46 | 175 | | 292 | 37.09 | 53.3% | |

TABLE II

| Code | Chemical Composition (XRF-Weight percent) | | | | | | | | | | | |
|---|---|---|---|---|---|---|---|---|---|---|---|---|
| LTP | CaO | MgO | P2O5 | SiO2 | Al2O3 | Na2O | K2O | B2O3 | Fe2O3 | ZrO2 | SrO | Kl |
| LTP 8 | 24.95 | 19.18 | 3.41 | 51.69 | 0.25 | 0.30 | 0.05 | | 0.17 | | | 43.99 |
| LTP11 | 25.13 | 19.07 | 2.51 | 52.54 | 0.28 | 0.25 | 0.05 | | 0.17 | | | 43.94 |
| LTP49 | 32.35 | 6.74 | | 50.54 | 0.57 | 0.40 | 0.08 | 9.17 | 0.14 | | | 47.60 |
| LTP 9 | 24.81 | 18.66 | 5.10 | 50.42 | 0.38 | 0.31 | | | 0.17 | 0.15 | | 43.03 |
| LTP67 | 15.17 | 25.18 | 5.06 | 54.00 | 0.19 | 0.25 | | | 0.15 | | | 40.22 |
| LTP13 | 11.28 | 27.95 | 3.26 | 57.20 | | 0.13 | | | 0.17 | | | 39.36 |
| LTP62 | 14.99 | 24.54 | 2.52 | 57.24 | 0.35 | 0.19 | | | 0.16 | | | 39.02 |
| LTP 7 | 10.37 | 27.85 | 3.29 | 58.18 | | 0.15 | | | 0.16 | | | 38.37 |
| LTP10 | 24.48 | 17.89 | 2.48 | 54.46 | 0.21 | 0.28 | 0.05 | | 0.16 | | | 42.28 |
| LTP 4 | 24 04 | 17.78 | 3.31 | 53.85 | 0.31 | 0 26 | 0.05 | | 0.15 | 0.25 | | 41.52 |
| LTP16 | 31.83 | 12 27 | 3.39 | 51.59 | 0.26 | 0.42 | 0 06 | | 0.17 | | | 44.07 |
| LTP 5 | 24.22 | 17.17 | 4.91 | 52.72 | 0.33 | 0.30 | | | 0.14 | 0.21 | | 41.04 |
| LTP59 | 32.13 | 10.47 | 12.93 | 41.37 | 2.31 | 0.56 | 0.05 | | 0.17 | | | 38.59 |
| LTP50 | 31.00 | 10.40 | | 54 50 | 0.36 | 0.31 | 0.08 | 3.19 | 0.16 | | | 44.26 |
| LTP17 | 38.39 | 5.54 | 3.41 | 51.22 | 0.40 | 0.42 | 0.07 | | 0.16 | 0.38 | | 43.62 |
| LTP56 | 34.38 | 9.46 | 14.72 | 40.02 | 0.72 | 0.55 | | | 0.16 | | | 42.95 |
| LTP23 | 38.62 | 5 56 | 2.57 | 52.23 | 0.34 | 0.46 | 0.07 | | 0.15 | | | 44.03 |
| LTP57 | 34.73 | 9.55 | 19.83 | 35.24 | 0.23 | 0.26 | | | 0.15 | | | 44.08 |
| LTP70 | 24.38 | 14.20 | | 57.52 | 0 44 | 0 18 | 0.08 | 3.01 | 0.18 | | | 40.97 |
| LTP63 | 14.61 | 22.87 | 2.53 | 59.45 | 0.27 | 0.12 | | | 0.16 | | | 37.06 |

Above here compositions have deviation of more than 2.4 wt %

| | | | | | | | | | |
|---|---|---|---|---|---|---|---|---|---|
| LTP54 | 29.40 | 8.73 | 14.55 | 46.68 | 0.07 | 0.44 | | 0.13 | 38.43 |
| LTP61 | 32.46 | 9.86 | 14.02 | 42.67 | 0.09 | 0.70 | 0.05 | 0.15 | 42.89 |
| LTP60 | 31.46 | 9.58 | 12.64 | 44 91 | 0.69 | 0.54 | 0.05 | 0.14 | 40.25 |

Above here compositions have P2O5 content more than 12.5 wt %

| | | | | | | | | | |
|---|---|---|---|---|---|---|---|---|---|
| LTP52 | 24.93 | 11.52 | 4.90 | 54.88 | 2.06 | 0.28 | 0.05 | 1.38 | 32.66 |
| LTP51 | 28.72 | 11.01 | 1.62 | 56.65 | 1.38 | 0.29 | 0.07 | 0.26 | 37.33 |

Above here fibres have Al2O3 content above 1 wt %

| | | | | | | | | | | |
|---|---|---|---|---|---|---|---|---|---|---|
| LTP15 | 36.89 | 5.70 | 5.05 | 51.22 | 0.31 | 0.43 | 0.10 | 0.16 | 0.13 | 42.50 |
| LTP14 | 30.93 | 11.01 | 4.90 | 51.96 | 0.30 | 0.45 | 0.05 | 0.15 | 0.25 | 41.85 |
| LTP58 | 32.93 | 9.77 | 12.01 | 44.34 | 0.19 | 0.53 | 0.05 | 0.19 | | 42.90 |
| LTP55 | 32.58 | 9.47 | 9.65 | 46.79 | 0.84 | 0.46 | 0.05 | 0.17 | | 40.88 |
| LTP53 | 29.34 | 9.84 | 9.58 | 50.26 | 0.17 | 0.56 | 0.05 | 0.15 | 0.05 | 39.45 |

Above here SiO2 content less than 52 wt %

| | | | | | | | | | | |
|---|---|---|---|---|---|---|---|---|---|---|
| LTP 3 | 22.89 | 16.69 | 6.70 | 52.58 | 0.25 | 0.29 | | 0.14 | 0.46 | 39.37 |
| LTP20 | 31.05 | 11.35 | 2.52 | 54.14 | 0.32 | 0 31 | 0.06 | 0.16 | 0.10 | 42.13 |
| LTP 2 | 23.35 | 16.10 | 4.87 | 54.25 | 0.46 | 0.24 | | 0.16 | 0.58 | 38.77 |
| LTP12 | 30.93 | 11.35 | 3.36 | 53.52 | 0.32 | 0.31 | 0.06 | 0.15 | | 42.00 |
| LTP21 | 36.62 | 5.58 | 2.54 | 54.19 | 0.39 | 0.46 | 0.07 | 0.15 | | 41.95 |
| LTP48 | 31.90 | 6.85 | 7.78 | 52.24 | 0.52 | 0.34 | 0.05 | 0.15 | 0.18 | 38.10 |

10/34 Above here SiO2 content 52 wt % to less than 55 wt %

| | | | | | | | | | | | | |
|---|---|---|---|---|---|---|---|---|---|---|---|---|
| LTP47 | 22.30 | 17.48 | 4.00 | 55.45 | 0.31 | 0.31 | 0.05 | | 0.10 | | | 39.52 |
| LTP64 | 20 81 | 18.41 | 2 52 | 57.63 | 0.22 | 0.26 | | | 0 14 | | | 39.04 |
| LTP68 | 20 08 | 18.77 | 4.55 | 55.92 | 0.30 | 0.24 | | | 0.14 | | | 38.49 |
| LTP29 | 40.29 | 2.09 | 1.23 | 55.09 | 0.43 | 0 39 | 0.12 | | 0.19 | 0.17 | | 42.03 |
| LTP41 | 31.36 | 9.48 | 0.85 | 55.63 | 0.27 | 0.30 | 0.07 | 1.88 | 0.16 | | | 42.55 |
| LTP71 | 38.31 | 0.65 | | 56.51 | 0.55 | 0.20 | 0.09 | 3.54 | 0.14 | | | 41.69 |
| LTP30 | 39.40 | 1.96 | 2.22 | 55.25 | 0.45 | 0.41 | 0.10 | | 0.21 | | | 40.96 |
| LTP 1 | 23.29 | 15.66 | 3.33 | 57.01 | 0.24 | 0.22 | 0.06 | | 0.14 | | 0.05 | 38.74 |
| LTP43 | 30.51 | 9.68 | 1.68 | 56.19 | 0.28 | 0.32 | 0.07 | 1.11 | 0.15 | | | 41.13 |
| LTP37 | 35.40 | 4.77 | | 57.92 | 0.31 | 0.31 | 0.09 | 1.05 | 0.15 | | | 40.99 |
| LTP32 | 30.01 | 8.53 | | 57.95 | 0.32 | 0.23 | 0.09 | 2.69 | 0.18 | | | 40.92 |
| LTP73 | 36.93 | 0.62 | | 57.96 | 0.49 | 0.23 | 0.09 | 3.54 | 0.13 | | | 40.43 |
| LTP42 | 30.55 | 9.56 | 0.86 | 57.13 | 0.27 | 0.33 | 0.07 | 1.08 | 0.15 | | | 41.06 |
| LTP38 | 34.82 | 4.73 | 0.82 | 57.84 | 0.31 | 0.30 | 0.08 | 0.94 | 0.15 | | | 40.26 |
| LTP40 | 33.67 | 4.75 | 0.86 | 57.85 | 0.38 | 0.31 | 0.08 | 1.95 | 0.15 | | | 40.00 |
| LTP 6 | 29.83 | 10.45 | 3.34 | 55.65 | 0.21 | 0.32 | 0.05 | | 0.15 | | | 40.23 |
| LTP69 | 19.17 | 17.56 | 4.66 | 57.93 | 0.31 | 0.23 | | | 0.13 | | | 36.34 |
| LTP34 | 30.44 | 9.81 | 1.68 | 57.30 | 0.25 | 0.31 | 0.07 | | 0.15 | | | 40.13 |
| LTP39 | 34.35 | 4.73 | 1.67 | 57.39 | 0.27 | 0.30 | 0.08 | 1.06 | 0.14 | | | 39.98 |
| LTP26 | 33.69 | 4.56 | 3.73 | 56.95 | 0.36 | 0.43 | 0.06 | | 0.14 | 0.07 | | 38.02 |
| LTP27 | 28.91 | 9.33 | 3.66 | 57.32 | 0.22 | 0.36 | 0.05 | | 0.14 | | | 38.21 |

Above here SiO2 content 55 wt % to less than 58 wt %

| | | | | | | | | | | | |
|---|---|---|---|---|---|---|---|---|---|---|---|
| LTP66 | 15.65 | 21.16 | 4.38 | 58.17 | 0.24 | 0.25 | | | 0.15 | | 36.58 |
| LTP65 | 20.36 | 17.74 | 2.50 | 58.75 | 0.30 | 0.22 | | | 0.13 | | 37.72 |
| LTP72 | 22.67 | 13 60 | | 59.64 | 0.37 | 0.27 | 0.06 | 3.25 | 0.14 | | 39.11 |
| LTP35 | 32.72 | 4.76 | | 58.60 | 0.28 | 0.31 | 0.08 | 3.09 | 0.15 | | 40.40 |
| LTP31 | 28 30 | 9.20 | | 58.70 | 0.28 | 0.29 | 0.06 | 3.00 | 0.18 | | 40.29 |
| LTP36 | 33.37 | 4.82 | | 58.90 | 0.27 | 0.30 | 0.08 | 2.10 | 0.15 | | 40.13 |
| LTP33 | 30.20 | 9.03 | | 59.01 | 0.27 | 0.28 | 0.08 | 0.96 | 0.17 | | 40.02 |
| LTP44 | 29.05 | 6.88 | | 59.81 | 0.35 | 0.36 | 0.07 | 3.16 | 0.13 | 0.19 | 38.82 |
| LTP45 | 24.10 | 11.40 | | 62.48 | 0.54 | 0.24 | 0.06 | 1.04 | 0.15 | | 35.76 |
| LTP46 | 28.52 | 8.73 | 2.68 | 59.25 | 0.29 | 0.33 | 0.06 | | 0.13 | | 37.06 |

Above here SiO2 content 58 wt % or more

| Code | Shrinkage | | | Solubility (ppm) | | | | | CaO + | |
|---|---|---|---|---|---|---|---|---|---|---|
| LTP | 800° C. | 1000° C. | Deviation | CaO | MgO | SiO2 | B2O3 | Total | MgO | % N.B.O. |
| LTP 8 | 40.00 | 40.00 | −7.49 | 53 | 98 | 177 | | 328 | 44.14 | 68.5% |
| LTP11 | 46.80 | 39.10 | −7.48 | 55 | 94 | 174 | | 323 | 44.20 | 68.0% |
| LTP49 | 2.65 | 15.70 | −7.46 | 79 | 41 | 214 | 129 | 463 | 39.09 | 62.1% |
| LTP 9 | 23.90 | 38.80 | −6.81 | 59 | 115 | 193 | | 367 | 43.47 | 68.1% |
| LTP67 | 5.70 | — | −6.53 | | | | | | 40 35 | 64.9% |
| LTP13 | 5.72 | 5.26 | −6.51 | 30 | 117 | 188 | | 335 | 39.23 | 63.0% |
| LTP62 | 4.48 | — | −5.51 | 25 | 66 | 119 | | 210 | 39.53 | 62.3% |
| LTP 7 | 10.90 | 15.50 | −5.46 | 36 | 132 | 152 | | 320 | 38.23 | 61.4% |
| LTP10 | 3.62 | 19.10 | −5.01 | 58 | 90 | 169 | | 317 | 42.37 | 64.7% |
| LTP 4 | 3.71 | 4.77 | −4.73 | 56 | 95 | 180 | | 331 | 41 83 | 64.3% |
| LTP16 | 49.10 | — | −4.15 | 79 | 76 | 200 | | 355 | 44 11 | 66 1% |
| LTP 5 | 3.63 | 5 39 | −3.96 | 65 | 106 | 191 | | 362 | 41 40 | 64.1% |
| LTP59 | 43.20 | — | −3.94 | 42 | 41 | 179 | | 262 | 42.60 | 69 3% |
| LTP50 | 29.80 | — | −3.70 | 79 | 58 | 200 | 30 | 367 | 41 40 | 62 0% |
| LTP17 | 45.20 | 43.80 | −3.37 | 83 | 32 | 191 | | 306 | 43.94 | 63.9% |
| LTP56 | 9.98 | — | −3.26 | 60 | 57 | 196 | | 313 | 43.84 | 70 5% |
| LTP23 | 42.90 | — | −3.20 | 82 | 29 | 199 | | 310 | 44.18 | 63.7% |
| LTP57 | — | — | −2 93 | | | | | 0 | 44.28 | 73.0% |
| LTP70 | 3.36 | 7.86 | −2.58 | 75 | 73 | 255 | 21 | 424 | 38 58 | 58 7% |
| LTP63 | 9.57 | — | −2.46 | 17 | 108 | 83 | | 208 | 37.48 | 58.4% |

Above here compositions have deviation of more than 2.4 wt %

| | | | | | |
|---|---|---|---|---|---|
| LTP54 | — | — | 3.23 | 38.13 | 60.1% |
| LTP61 | 3.44 | 3.65 | −1.31 | 42.32 | 67.4% |
| LTP60 | — | — | −0.45 | 41 04 | 64.8% |

Above here compositions have P2O5 content more than 12.5 wt %

| | | | | | | | | | |
|---|---|---|---|---|---|---|---|---|---|
| LTP52 | 32.10 | — | 1.02 | 72 | 74 | 140 | 286 | 36.45 | 56.1% |
| LTP51 | 3.07 | 3.61 | −0.24 | 82 | 69 | 159 | 310 | 39.73 | 58.4% |

Above here fibres have Al2O3 content above 1 wt %

| | | | | | | | | | |
|---|---|---|---|---|---|---|---|---|---|
| LTP15 | 3.41 | 5.03 | −1.72 | 88 | 35 | 204 | 327 | 42.59 | 62.2% |
| LTP14 | 3.24 | 3.92 | −1.65 | 78 | 69 | 191 | 338 | 41.95 | 63.0% |
| LTP58 | 2.62 | 2.78 | −1.65 | 57 | 42 | 223 | 322 | 42.70 | 67.0% |
| LTP55 | 1.72 | 1.95 | −1.56 | 71 | 54 | 203 | 328 | 42.05 | 65.1% |
| LTP53 | 0.01 | 0.00 | 1.84 | 71 | 83 | 222 | 376 | 39.18 | 60.1% |

Above here SiO2 content less than 52 wt %

| | | | | | | | | | |
|---|---|---|---|---|---|---|---|---|---|
| LTP 3 | 23.30 | 29.50 | −2.07 | 43 | 166 | 141 | 350 | 39.58 | 61.9% |
| LTP20 | 3.38 | 29.70 | −2.01 | 85 | 71 | 200 | 356 | 42.40 | 62.6% |
| LTP 2 | 2.24 | 3.05 | −1.93 | 53 | 96 | 167 | 316 | 39.45 | 60.8% |
| LTP12 | 2.55 | 30.10 | −1.79 | 82 | 72 | 207 | 361 | 42.27 | 62.6% |
| LTP21 | — | 35.50 | −1.27 | 58 | 34 | 208 | 300 | 42.20 | 60 3% |
| LTP48 | 1.24 | 1.53 | 2.02 | 84 | 48 | 205 | 337 | 38.75 | 57.7% |

Above here SiO2 content 52 wt % to less than 55 wt %

| | | | | | | | | | | |
|---|---|---|---|---|---|---|---|---|---|---|
| LTP47 | 1.97 | 2.14 | −2.29 | 58 | 104 | 197 | | 359 | 39.78 | 61.0% |
| LTP64 | 3.01 | 3.73 | −2 05 | 46 | 76 | 197 | | 319 | 39.22 | 59.7% |
| LTP68 | 3.90 | 4.16 | −1.92 | 51 | 89 | 226 | | 366 | 38.85 | 60 2% |
| LTP29 | 45.85 | — | −1.68 | 76 | 10 | 206 | | 292 | 42.38 | 58 8% |
| LTP41 | 1.20 | 2.32 | −1.52 | 87 | 60 | 194 | 20 | 361 | 40.84 | 60.0% |
| LTP71 | 0.59 | 1.43 | −1.49 | 73 | 2 | 278 | 55 | 408 | 38.96 | 54.9% |
| LTP30 | 1.74 | 2.04 | −0.53 | 72 | 11 | 209 | | 292 | 41.36 | 57.5% |
| LTP 1 | 1.31 | 1.77 | −0.49 | 63 | 89 | 175 | | 327 | 38.94 | 58.7% |
| LTP43 | 0.97 | 1.84 | −0.12 | 62 | 66 | 187 | 12 | 327 | 40.19 | 58.8% |
| LTP37 | 1.57 | 2.13 | −0.08 | 37 | 30 | 195 | 13 | 275 | 40.16 | 56.1% |
| LTP32 | 1.68 | 2.83 | −0.05 | 80 | 46 | 184 | 24 | 334 | 38.54 | 56.3% |
| LTP73 | 1.23 | 3.00 | −0.04 | 76 | 2 | 264 | 40 | 382 | 37.55 | 52.6% |
| LTP42 | 1.04 | 1.81 | −0.02 | 75 | 65 | 192 | 12 | 344 | 40.12 | 58.2% |
| LTP38 | 1.07 | 1.40 | 0.66 | 83 | 25 | 175 | 9 | 292 | 39.56 | 55.4% |
| LTP40 | 1.15 | 2.39 | 0.71 | 40 | 32 | 194 | 25 | 291 | 38.42 | 54.5% |
| LTP 6 | 1.89 | 2.76 | 0.76 | 65 | 52 | 172 | | 289 | 40.28 | 59.0% |
| LTP69 | 1.23 | 1.68 | 0.81 | 49 | 88 | 241 | | 378 | 36.73 | 56.5% |
| LTP34 | 1.40 | 1.79 | 0.98 | 76 | 51 | 188 | | 315 | 40.25 | 58.0% |
| LTP39 | 1.47 | 1.93 | 1.06 | 32 | 33 | 203 | 16 | 284 | 39.08 | 55.2% |
| LTP26 | 1.22 | 1.40 | 2.68 | 91 | 28 | 193 | | 312 | 38.25 | 54.0% |
| LTP27 | 0.99 | 1.16 | 2.99 | 67 | 48 | 173 | | 288 | 38.24 | 55.5% |

Above here SiO2 content 55 wt % to less than 58 wt %

| | | | | | | | | | | |
|---|---|---|---|---|---|---|---|---|---|---|
| LTP66 | 2.65 | 3.19 | −1.03 | 30 | 84 | 169 | | 283 | 36.81 | 57.7% |
| LTP65 | 2.28 | 2.37 | −0.62 | 41 | 68 | 185 | | 294 | 38.10 | 57.6% |
| LTP72 | 3.37 | 6.16 | −0.16 | 49 | 56 | 197 | 23 | 325 | 36.27 | 55 0% |
| LTP35 | 1.65 | 3.85 | 0.60 | 88 | 26 | 179 | 29 | 322 | 37.48 | 53 5% |
| LTP31 | 3.15 | 4.88 | 0.70 | 91 | 60 | 205 | 31 | 387 | 37.50 | 55.1% |
| LTP36 | 1.50 | 3.12 | 0.90 | 37 | 33 | 198 | 25 | 293 | 38.19 | 53.9% |
| LTP33 | 2.16 | 2.74 | 1.01 | 88 | 52 | 193 | 10 | 343 | 39.23 | 56.1% |
| LTP44 | 1.60 | 2.71 | 1.81 | 89 | 44 | 193 | 32 | 358 | 35.93 | 52.1% |
| LTP45 | 2.17 | 3.15 | 3.78 | 81 | 65 | 189 | 10 | 345 | 35.50 | 51.3% |
| LTP46 | 0.91 | 0.99 | 3.93 | 71 | 46 | 175 | | 292 | 37.25 | 53.3% |

Above here SiO2 content 58 wt % or more

1. The use of either or both P₂O₅ and B₂O₃ as a component to improve the refractoriness of inorganic fibres comprising SiO₂, and CaO and/or MgO, to produce inorganic fibres having a composition having a shrinkage of less than 3.5% when exposed to 1000° C. for 24 hours and having a shrinkage of less than 3.5% when exposed to 800° C. for 24 hours, the fibres having a composition:

| | |
|---|---|
| SiO₂ | 44 wt % or more |
| CaO | 20-40 wt % |
| MgO | 0-18 wt % |
| P₂O₅ | 0-12.5 wt % |
| B₂O₃ | 0-4 wt % |

and in which
SiO₂+P₂O₅-(58+(if MgO>10, 0.5×(MgO-10) else 0))>-2.4 wt %

2. The use of either or both P₂O₅ and B₂O₃ as a component to improve the refractoriness of inorganic fibres as claimed in claim 1 in which the percentage of non-bridging oxygens is less than 61.4%.

3. The use of either or both P₂O₅ and B₂O₃ as a component to improve the refractoriness of inorganic fibres as claimed in claim 1 in which the fibres fall within the compositional range:

| | |
|---|---|
| SiO₂ | 52-<58 wt % [52-<58 + 0.5 × (MgO-10)wt % |
| | if MgO > 10 wt %] |
| CaO | 22-40 wt % |
| MgO | 0-17.5 wt % |
| MgO + CaO | <42 wt % |
| P₂O₅ | 0.5-10 wt % |
| B₂O₃ | 0-2 wt %. |

4. The use of either or both P₂O₅ and B₂O₃ as a component to improve the refractoriness of inorganic fibres in which the fibres fall within the compositional range:

| | |
|---|---|
| SiO₂ | 44.34-62.48 |
| CaO | 20.36-39.4 wt % |
| MgO | 0.62-21.16 wt % |
| P₂O₅ | 0-12.01 wt % |
| B₂O₃ | 0-3.54 wt % |

and in which
SiO₂+P₂O₅-(58+(if MgO>10, 0.5×(MgO-10) else 0))>-2.4 wt %

5. Saline soluble inorganic fibres having a shrinkage of less than 3.5% when exposed to 1000° C. for 24 hours and having a shrinkage of less than 3.5% when exposed to 800° C. for 24 hours, in which:
SiO₂+P₂O₅-(58+(if MgO>10, 0.5×(MgO-10) else 0))>-2.4 wt %
and comprising:

| | |
|---|---|
| SiO₂ | 52-<58 wt % [52-<58 + 0.5′(MgO-10)wt % if |
| | MgO > 10 wt %] |
| CaO | 22-40 wt % |
| MgO | 0-17.5 wt % |
| MgO + CaO | <42 wt % |
| P₂O₅ | 0.5-10 wt % |
| B₂O₃ | 0-2 wt % |

and in which the percentage of non-bridging oxygens calculated on the basis of the amounts of the above named components is less than 61.4%.

6. Saline soluble inorganic fibres having a shrinkage of less than 3.5% when exposed to 1000° C. for 24 hours and having a shrinkage of less than 3.5% when exposed to 800° C. for 24 hours, in which:
SiO₂+P₂O₅-(58+(if MgO>10, 0.5×(MgO-10) else 0))>-2.4 wt %
and comprising:

| | |
|---|---|
| SiO₂ | 44.34-62.48 |
| CaO | 20.36-39.4 wt % |
| MgO | 0.62-21.16 wt % |

and also comprising either or both of:-

| | |
|---|---|
| P₂O₅ | 0-12.01 wt % |
| B₂O₃ | 0-3.54 wt %. |

7. Saline soluble inorganic fibres having a shrinkage of less than 3.5% when exposed to 1000° C. for 24 hours and having a shrinkage of less than 3.5% when exposed to 800° C. for 24 hours, in which:
SiO₂+P₂O₅-(58+(if MgO>10, 0.5×(MgO-10) else 0))>-2.4 wt %
and comprising:

| | |
|---|---|
| SiO₂ | 52.4-57.85 wt % |
| CaO | 22.2-39.4 wt % |
| MgO | 1.96-17.4 wt % |
| P₂O₅ | 0.82-7.8 wt % |
| B₂O₃ | 0-1.95 wt % |
| Al₂O₃ | <1 wt % |
